(19) United States
(12) Patent Application Publication
(10) Pub. No.: US 2013/0265887 A1
(43) Pub. Date: Oct. 10, 2013

(54) SMALL FORM FACTOR PLUGGABLE UNIT WITH SIGNAL MONITORING CAPABILITIES

(71) Applicants: Renaud LAVOIE, Laval (CA); Eric DUDEMAINE, Crabtree (CA)

(72) Inventors: Renaud LAVOIE, Laval (CA); Eric DUDEMAINE, Crabtree (CA)

(21) Appl. No.: 13/440,055

(22) Filed: Apr. 5, 2012

(51) Int. Cl. H04L 12/26

(52) U.S. Cl. 370/252; 370/241

(57) ABSTRACT

The present disclosure relates to small form factor pluggable units (SFP) having a monitoring probe. The monitoring probe is capable of monitoring a signal received by the SFP unit, in order to analyze the received signal and to generate a status signal. The monitoring probe may monitor a received signal directly or a copy thereof. The monitoring probe may be non-intrusive of the received signal, or intrusive. The monitoring probe may further generate a diagnostic of the received signal.

### TECHNICAL FIELD

The present disclosure relates to the field of Small Form-factor Pluggable (SFP) units; and more particularly to an SFP unit with signal monitoring capabilities.

### BACKGROUND

Small Form-factor Pluggable (SFP) units are standardized units adapted to be inserted within a chassis. A set of specifications, produced by the SFF (Small Form Factor) Committee, describe the size of the SFP unit, so as to ensure that all SFP compliant units may be inserted smoothly within one same chassis, i.e. inside cages, ganged cages, superposed cages and belly-to-belly cages. Specifications for SFP units are available at http://www.sffcommittee.com/ie/index.html.

SFP units may be used with various types of external connectors, such as coaxial connectors, optical connectors, and various other types of electrical connectors. In general, an SFP unit allows connection between an external apparatus, via a front connector of one of the aforementioned types, and internal components of a host system, for example a motherboard or a backplane leading to further components, via a back interface of the SFP unit. Specification no INF-8074i Rev 1.0, entitled “SFP (Small Form factor Pluggable) Transceiver”, dated May 12, 2001, available at ftp://ftp.seagate.com/sff/INF-8074.PDF, generally describes sizes, mechanical interfaces, electrical interfaces and identification of SFP units.

SFP units are typically used in networks where hundreds and sometimes thousands of signals and connections are carried and performed. Troubleshooting such networks is a tedious task, as the granularity of the information available is not sufficient to identify the source of the problem. It is also difficult to assess the extent of the problems, as well as performing overview of the network performance. There is therefore a need for an SFP unit adapted for performing signal monitoring.

### SUMMARY

The present disclosure relates to the field of Small Form-factor Pluggable (SFP) units; and more particularly to an SFP unit with signal monitoring capabilities.

According to a first aspect, the present disclosure provides an SFP unit comprising at least one input for receiving a signal, a monitoring probe for monitoring the received signal and generating a status signal, and an output for sending the status signal.

According to a second aspect, the present disclosure provides an SFP unit comprising at least one input for receiving a signal, a processing unit for processing the received signal and generating a processed signal, a monitoring probe for monitoring the processed signal and generating a status signal, and an output for outputting the status signal.

According to a third aspect, the present disclosure provides an SFP unit comprising a non-intrusive monitoring probe, operating on a copy of one of the received signal and the processed signal.

According to a fourth aspect, the present disclosure provides an SFP unit comprising an intrusive monitoring probe, operating on the processed signal.

According to a fifth aspect, the present disclosure provides an SFP unit comprising a monitoring probe, capable of generating a diagnostic based on the results of the monitoring of the processed signal.

The foregoing and other features will become more apparent upon reading of the following non-restrictive description of examples of implementation thereof, given by way of illustration only with reference to the accompanying drawings.

### BRIEF DESCRIPTION OF THE DRAWINGS

In the appended drawings:

FIG. 1 schematically illustrates an exemplary SFP, according to a non-restrictive illustrative embodiment;

FIGS. 2A, 2B, 2C, and 2D schematically illustrate an SFP unit comprising a monitoring and diagnostic probe, according to non-restrictive illustrative embodiments;

FIGS. 3A and 3B schematically illustrate other exemplary embodiments of the SFP unit with a monitoring and diagnostic probe;

FIGS. 4A and 4B schematically illustrate other exemplary embodiments of the SFP unit with a monitoring and diagnostic probe;

FIGS. 5A and 5B schematically illustrate other exemplary embodiments of the SFP unit with a monitoring and diagnostic probe;

FIGS. 6A and 6B schematically illustrate other exemplary embodiments of the SFP unit with a monitoring and diagnostic probe;

FIGS. 7A and 7B schematically illustrate other exemplary embodiments of the SFP unit with a monitoring and diagnostic probe;

FIGS. 8A and 8B schematically illustrate other exemplary embodiments of the SFP unit with a monitoring and diagnostic probe with two bi-directional ports, according to a non-restrictive illustrative embodiment;

FIG. 9 schematically illustrates an exemplary monitoring and diagnostic system, according to a non-restrictive illustrative embodiment.

### DETAILED DESCRIPTION

Throughout the present disclosure, the terms ‘input’ and ‘output’ are used. The term input refers to any type of input signal entering an SFP unit, such as for example an interface input and/or to an input from a host. In a similar manner, the term output refers to any type of output signal exiting an SFP unit, such as for example an interface output and/or to an output to a host

The expression ‘monitoring and diagnostic probe’ is used throughout the present disclosure and figures to refer to any probe that is adapted to monitor a signal, and only in optional embodiments also diagnose the signal.

The present disclosure relates to the field of Small Form-factor Pluggable (SFP) units; and more particularly to an SFP unit with signal monitoring capabilities. The SFP unit includes a monitoring and diagnostic probe, capable of monitoring a signal received by the SFP unit and/or a processed signal, and generating a status signal. The monitoring and diagnostic probe is also capable of generating a diagnostic, based on the monitoring of the received and/or processed signal. The SFP unit may further include a processing unit, which transforms and/or processes the received signal into a processed signal.

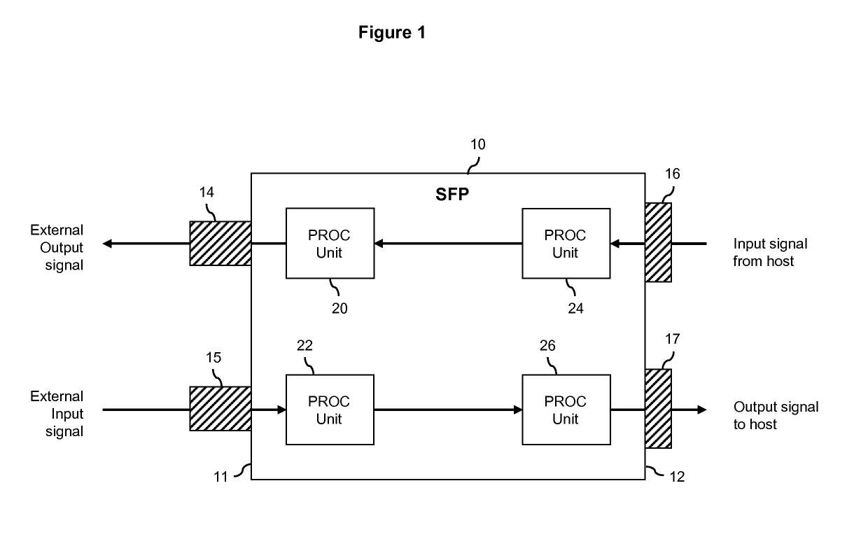

Referring now to FIG. 1, an exemplary SFP will be described.

The SFP unit 10 represented in FIG. 1 is a conventional SFP unit, and does not include a monitoring and diagnostic probe. The conventional SFP unit is represented for explaining the context in which the present monitoring probe may be incorporated. The conventional SFP unit includes at least one input 14 which may be connected to an external apparatus (not represented in FIG. 1), and one host interface 16 connected to a host system (not represented in FIG. 1). The input 14 may be designed to receive an external input signal (input), to send an external output signal (output), or to both receive an external input signal and send an external output signal (input/output bi-directional communication). Similarly, the host interface 16 may be designed to receive a host input signal, to send a host output signal, or to both receive a host input signal and send a host output signal. The SFP unit 10 may comprise more than one input and more than one output (connected to the same or different external apparatuses). Although reference is made herein to input and output, the present is not limited to unidirectional ports, and the input and output could alternately be replaced by input/output bi-directional ports.

The combination of input 14, output 15, host input 17 and host output 16, signals and processing units 20, 22, 24 and 26 is for exemplary purposes and may be rearranged in various ways.

In one embodiment, the processing unit 24 may consist in a re-clocker, and the processing unit 20 in a cable driver. The processing unit 22 may consist in an equalizer, and the processing unit 26 in a re-clocker. Other types of signal processing functionalities may be implemented by the processing units, as known to those skilled in the art. Furthermore, one processing unit may implement several signal processing functionalities. The processing unit may consist for example of a microprocessor, an FPGA (Field-Programmable Gate Array), an optical component such as a cable driver, a laser driver, an equalizer or limiting TIA.

The host interface 16 (or 17) may consist of a host connector to connect the SFP unit 10 to a backplane of a chassis, as known to those skilled in the art. The host interfaces 16 and 17 may be of the same type (e.g. electrical), or of different types (e.g. electrical and optical respectively).

The input 14 and output 15 may consist of an external connector providing, for instance, an electrical or an optical connection. Examples of external connectors in the context of the present disclosure comprise all types of coaxial cable connectors, all types of optical fiber connectors, a Serial Digital Interface (SDI) connector, a High-Definition Multimedia Interface (HDMI) connector, USB2, USB3, display port, Ethernet, a twisted pair connector (e.g. a Category 5 or Category 6 connector), and the like. Some of these external connector types are suitable for transmission of analog signals, video signals, digital signals or serial data signals, or both, as is well-known to those of ordinary skill in the art. The input 14 and output 15 may be of the same type (e.g. coaxial), or of different types (e.g. coaxial and optical respectively).

The SFP unit 10 comprises a housing (not represented in FIG. 1 for clarity purposes) having a front panel 11, a back panel 12, a top (not represented in FIG. 1), a bottom (not represented in FIG. 1), and two sides (not represented in FIG. 1). Furthermore, the SFP unit 10 may be fully-compliant or partially compliant with standardized SFP dimensions, such as SFP, XFP (10 Gigabit SFP), Xenpak, CFP, CFP2, XFP+, SFP+, QSFP, QSFP+ or any other standardized small form factor pluggable unit. The front panel 11 comprises one or several inputs and/or outputs (14 and 15). The back panel 12 comprises one or several host interfaces (16 and 17). In the context of the present disclosure, the SFP unit 10 may correspond to SFP, SFP+, XFP, CFP (C Form-factor Pluggable), QSFP (Quad Small Form-factor Pluggable), QSFP+, or any other known standards related to small form factor pluggable units.

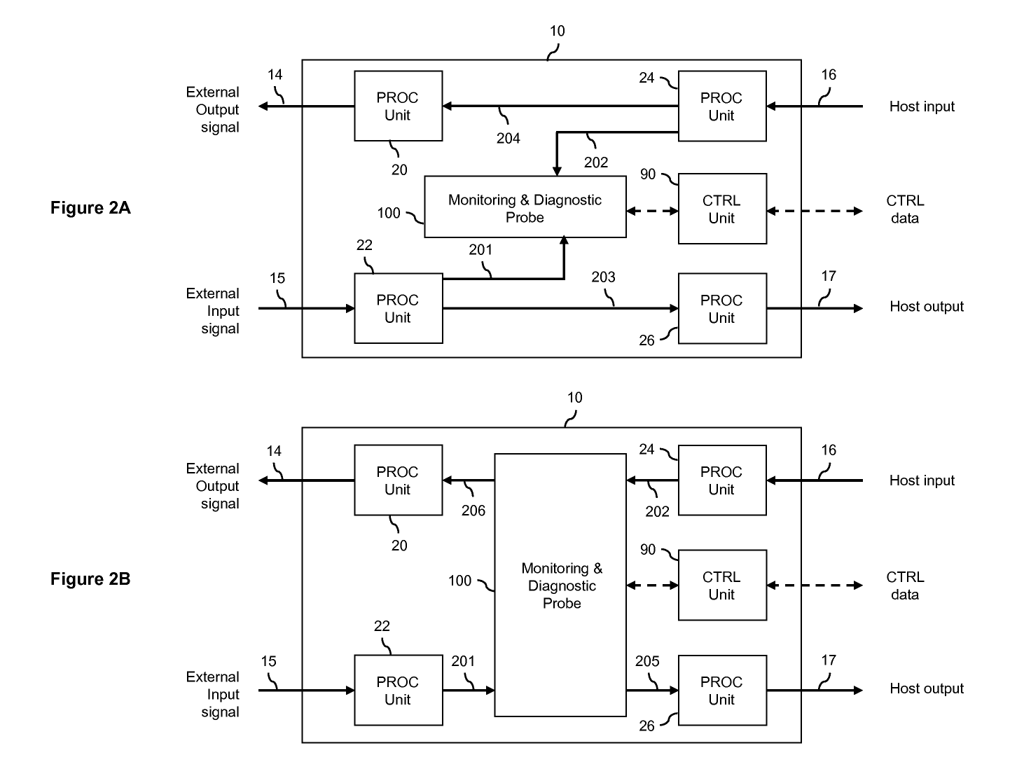

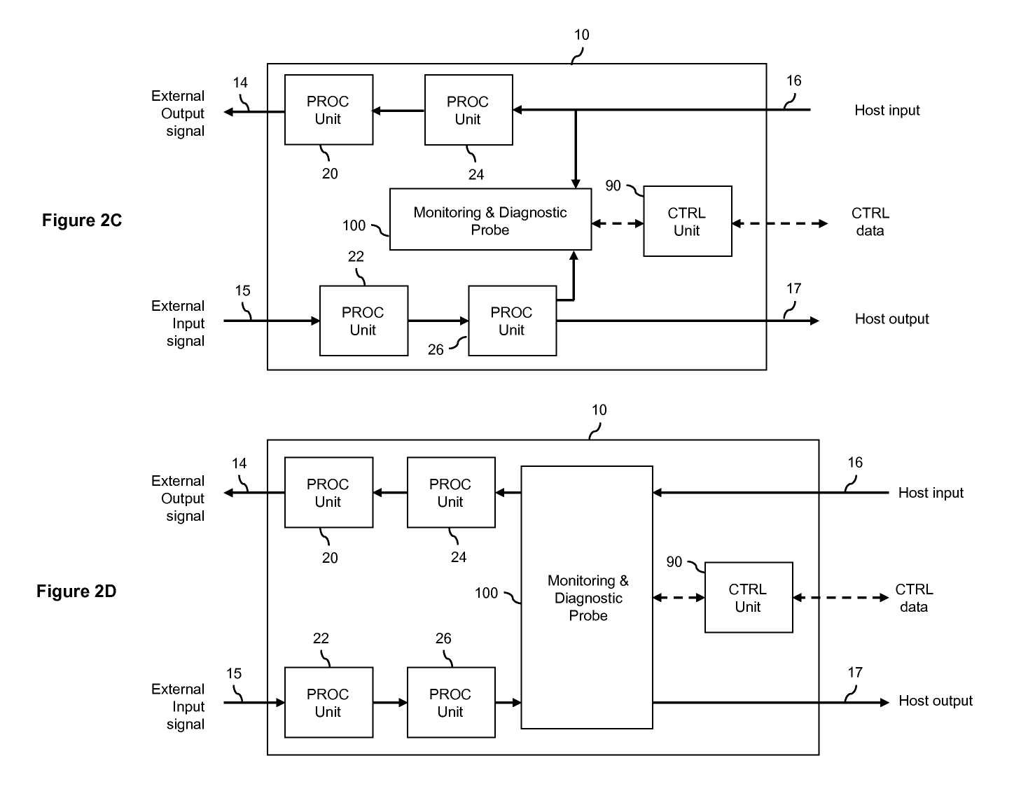

Referring now to FIGS. 2A, 2B, 2C, and 2D, an SFP unit including a monitoring and diagnostic in accordance with an embodiment will be described.

The SFP unit 10 represented in FIGS. 2A, 2B, 2C, and 2D is similar to the SFP unit represented in FIG. 1, to which the present monitoring and diagnostic probe 100, and optionally a control unit 90 are incorporated.

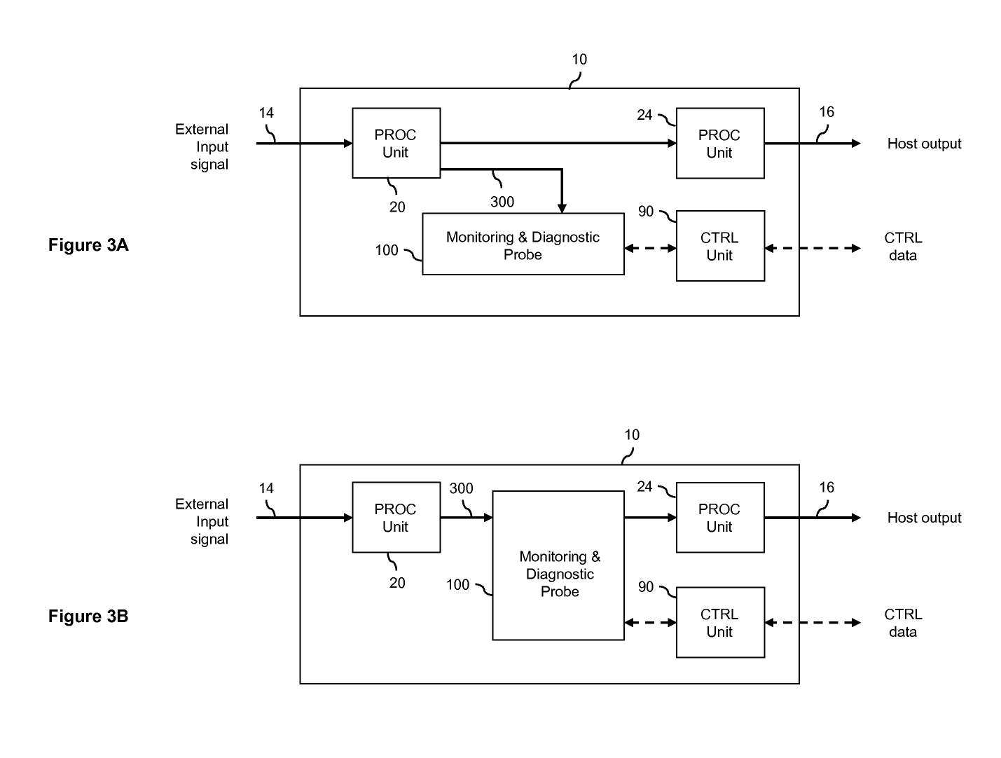

The monitoring and diagnostic probe 100 monitors at least one signal received by the SFP unit 10, an input such as a host input or via an external input. Based on the specific configuration of the SFP unit 10 in terms of number of external inputs, number of host inputs, and functionality of each interface (input/output/both), one or several signals received by the SFP unit 10 may be monitored. Furthermore, the monitoring and diagnostic probe 100 may monitor a received signal, a processed signal, resulting from the processing of the received signal by a processing unit, or combinations thereof. FIGS. 2A and 2B illustrate one specific configuration of the SFP unit 10, resulting in a specific implementation of the monitoring and diagnostic functionally 100. Alternatives configurations of the SFP unit 10, and the resulting implementations of the monitoring and diagnostic functionally 100, will be further detailed in relation to FIGS. 3 to 8.

More specifically, FIG. 2A represents a non-intrusive implementation of the present monitoring and diagnostic probe 100, while FIG. 2B represents an intrusive implementation of the present monitoring and diagnostic probe. In FIGS. 2A and 2B, the SFP unit 10 provides one input 15, the processing unit 22, the processing unit 26, and the host interface 17. The SFP unit 10 further provides one output, illustrated by the host interface 16, the processing unit 24, the processing unit 20, and the input 14.

For the input 15, the monitoring and diagnostic probe 100 monitors a processed signal 201 (in FIG. 2B) or a copy of the processed signal 201 (in FIG. 2A). For the output 14, the monitoring and diagnostic probe 100 monitors a processed signal 202 (in FIG. 2B) or a copy of the processed signal 202 (in FIG. 2A).

FIGS. 2C and 2D provide other schematic exemplary combinations of input 14, output 15, processing units, and their interconnection either intrusive or non-intrusive to the monitoring and diagnostic probe 100. Except for FIGS. 2C and 2D, the monitoring and diagnostic probe 100 is represented, in the present disclosure, as operating on a processed signal, the processed signal being the result of a processing of a received signal by one processing unit. This is for illustration purposes only, and shall not be interpreted in a limitative way. As mentioned above, the monitoring and diagnostic probe 100 may operate directly on a received signal, or on a processed signal generated by the processing of the received signal by one or several processing units. The processing units may operate in serial (or in parallel, or in a combination of serial and parallel processing).

The monitoring and diagnostic probe 100 monitors and analyse the signal received thereby, either the received signal or the processed signal, and generates therefor a status signal. The status signal may be sent by the monitoring and diagnostic probe 100 to one of the output 14, the host output 17 and/or a control unit.

In the case of an intrusive monitoring and diagnostic probe 100, as illustrated in FIG. 2B, in addition to generating and sending the status signal, the received signal (201 or 202) may be modified by the probe 100. Example of modifications which may be performed by the monitoring and diagnostic probe 100 on the received signal and/or processed signal may consist in a deliberate alteration of a content of the received signal (201 or 202). In one embodiment, the monitoring and diagnostic probe 100 is capable of detecting an alteration of an original content of the received signal (201 or 202), and to restore this original content. In another embodiment, the monitoring and diagnostic probe 100 may modify a content of the received signal (201 or 202). For example, the monitoring and diagnostic probe 100 may be capable of detecting an alteration of an original content of the received signal (201 or 202), but may not be able to restore this original content. Then, the content which has been altered may be modified, in a way to indicate that it is not valid.

The monitoring and diagnostic probe 100 may implement various monitoring functionalities, which consist in analyzing the received signal and/or the processed signal, and/or analyzing a content of the received signal. For example, analyzing the received signal and/or the processed signal may consist in at least one of: analysing an audio quality parameter of the received/processed signal, analysing a video quality parameter of the received/processed signal, analysing a digital quality parameter of a content of the received/processed signal, and analysing an integrity parameter of a content of the received/processed signal.

For example, if the received signal is a video signal, the following items may be monitored, extracted and analyzed: Horizontal and Vertical Ancillary Data (HANC, VANC), Vertical Blanking Interval (VBI), Wide Screen Signaling (WSS), freeze detection, black detection, video format, video rate, Cyclic Redundancy Check (CRC) error, generation of a thumbnail of an active video, thumbnailling, HD-SDTI detection, SDTI detection, audio presence, close captioning detect, teletext, Phase-Locked Loop (PLL) locked, jitter, eye diagram of the signal, video quality, metadata, audio presence, audio quality, audio metering, audio metadata, audience port status, etc . . .

The SFP unit 10 may further include a control unit 90, which exchanges control data with a control entity (not represented in FIGS. 2A and 2B) responsible for controlling the operations of the SFP unit 10. The control entity may be an entity of the host system, which is connected to the SFP unit 10 via the host input and output 16 and 17.

The operations of the monitoring and diagnostic probe 100 may be controlled by the control unit 90. For instance, the control unit 90 may receive control data from the control entity (not represented), which indicate what type of information shall be monitored, and which tests shall be performed, by the monitoring and diagnostic probe 100. The control unit 90 may further configure the monitoring and diagnostic probe 100, to operate in accordance with these control data.

The monitoring and diagnostic probe 100 may further generate a diagnostic, based on the results of the monitoring of the received/processed signal. The diagnostic may consist in a list of errors or problems detected on the received/processed signal. The diagnostic may be transmitted by the probe 100 to the control unit 90, which may further transmit it to the control entity (not represented in FIGS. 2A and 2B) in the form of control data. The diagnostic may further comprise inserting flags, watermarking, protection, security, verification codes, etc. in the received or processed signal. The diagnostic may further be transmitted in real time (each time an error or problem is detected). Alternatively, a diagnostic may be transmitted only periodically, and may consist of a list of the errors and problems which where detected over a reference period of time.

The monitoring and diagnostic probe 100 may be implemented by means of an FPGA board, an Application-Specific Integrated Circuit (ASIC) board; and the like. Although a single probe 100 is represented in FIGS. 2A and 2B, the monitoring and diagnostic functions of the SFP unit 10 may be implemented by more than one monitoring and diagnostic probe 100. For instance, a first monitoring and diagnostic probe 100 may be dedicated to the input of the SFP unit 10 (to monitor a received signal received from the input 15). And a second monitoring and diagnostic probe 100 may be dedicated to the output of the SFP unit 10 (to monitor a received signal received from the host interface 16).

The control unit 90 may be implemented by means of an FPGA board, an ASIC board, a Micro-Controller; and the like.

Referring now to FIGS. 3A and 3B, a monitoring and diagnostic probe for an SFP unit with one input will be described.

In FIGS. 3A and 3B, the SFP unit 10 provides one input, illustrated by the input 14, the processing unit 20, the processing unit 24, and the host output 16.

For the input 14, the monitoring and diagnostic probe 100 monitors a processed signal 300, generated by the processing (by the processing unit 20) of the external input signal received on the input 14.

FIG. 3A represents a non-intrusive monitoring and diagnostic probe 100, which operates on a copy 300 of the signal generated by the processing unit 20. And FIG. 3B represents an intrusive monitoring and diagnostic probe 100, which operates directly on the signal 300 generated by the processing unit 20.

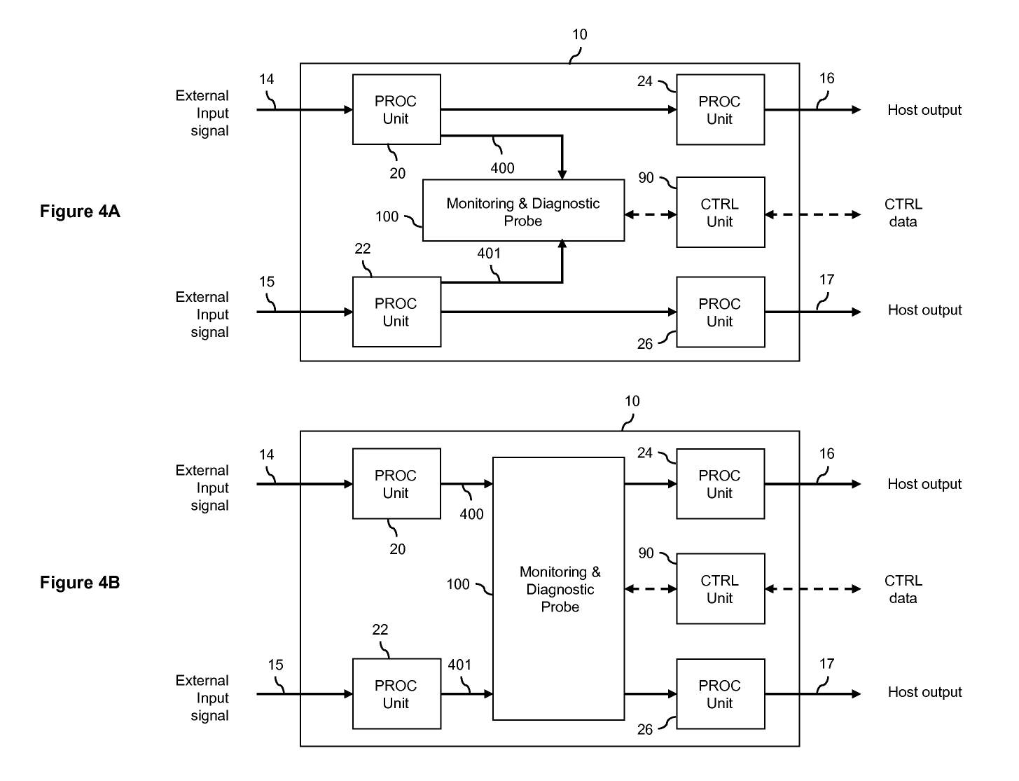

Referring now to FIGS. 4A and 4B, a monitoring and diagnostic probe for an SFP unit with two inputs will be described.

In FIGS. 4A and 4B, the SFP unit 10 provides a first input, illustrated by the input 14, the processing unit 20, the processing unit 24, and the host interface 16. And the SFP unit 10 provides a second input, illustrated by the input 15, the processing unit 22, the processing unit 26, and the host interface 17.

For the first input, the monitoring and diagnostic probe 100 monitors a processed signal 400, generated by the processing (by the processing unit 20) of the external input signal received on the input 14. For the second input, the monitoring and diagnostic probe 100 monitors a processed signal 401, generated by the processing (by the processing unit 22) of the external input signal received on the input 15.

FIG. 4A represents a non-intrusive monitoring and diagnostic probe 100, which operates on a copy (respectively 400 and 401) of a signal generated by a processing unit (respectively 20 and 22). And FIG. 4B represents an intrusive monitoring and diagnostic probe 100, which operates directly on a signal (respectively 400 and 401) generated by a processing unit (respectively 20 and 22).

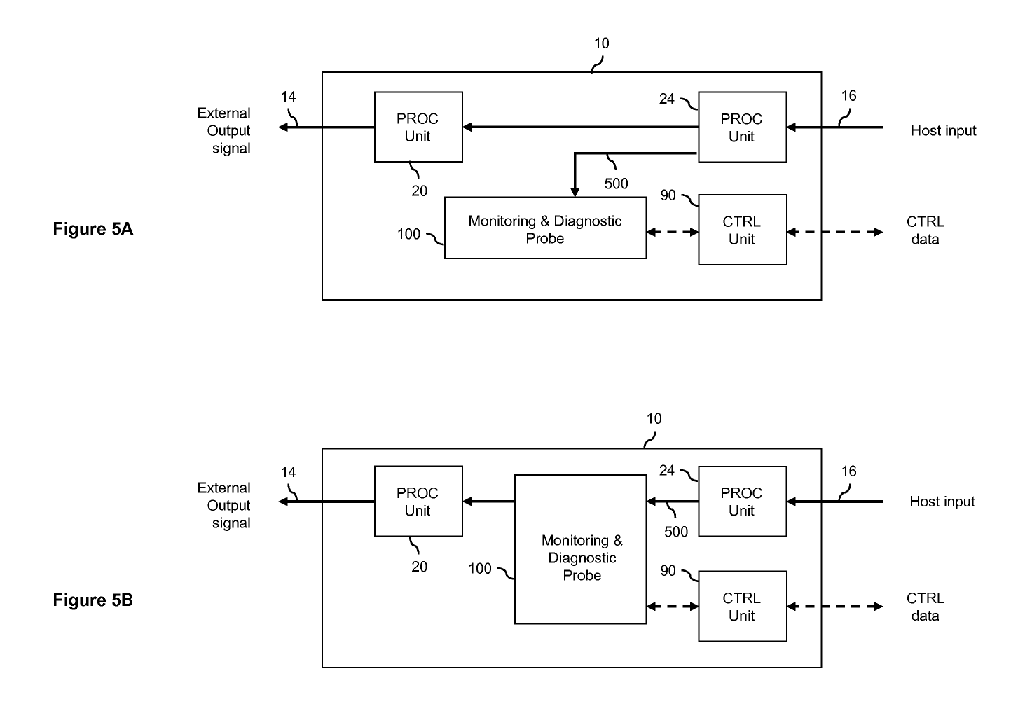

Referring now to FIGS. 5A and 5B, a monitoring and diagnostic probe for an SFP unit with one host input and one external output will be described.

In FIGS. 5A and 5B, the SFP unit 10 provides one host input 16, the processing unit 24, the processing unit 20, and the output 14.

For this output, the monitoring and diagnostic probe 100 monitors a processed signal 500, generated by the processing (by the processing unit 24) of the host input signal received on the host input 16.

FIG. 5A represents a non-intrusive monitoring and diagnostic probe 100, which operates on a copy 500 of the signal generated by the processing unit 24. And FIG. 5B represents an intrusive monitoring and diagnostic probe 100, which operates directly on the signal 500 generated by the processing unit 24.

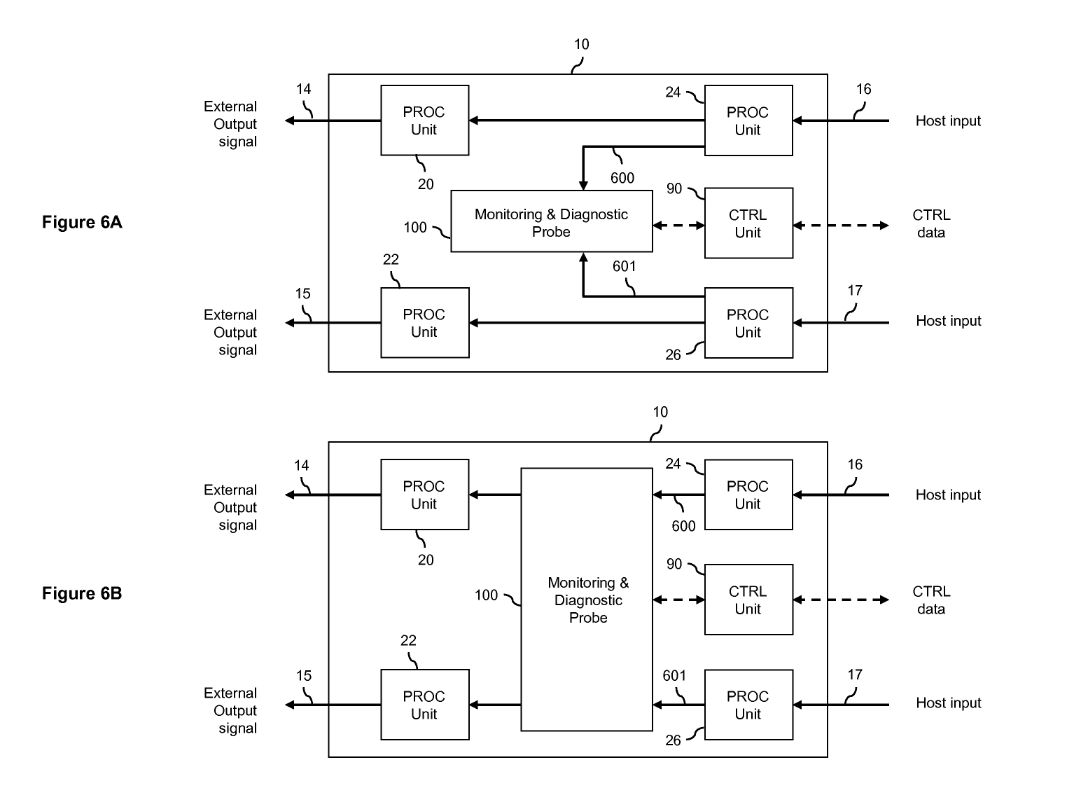

Referring now to FIGS. 6A and 6B, a monitoring and diagnostic probe for an SFP unit with two outputs will be described.

In FIGS. 6A and 6B, the SFP unit 10 provides a two host inputs 16 and 17, the processing unit 24, the processing unit 20, and two external outputs 14 and 15.

The monitoring and diagnostic probe 100 monitors a processed signal 600, generated by the processing (by the processing unit 24) of the host input signal received on the host input 16. The monitoring and diagnostic probe 100 also monitors a processed signal 601, generated by the processing (by the processing unit 26) of the host input 17 received signal.

FIG. 6A represents a non-intrusive monitoring and diagnostic probe 100, which operates on a copy (respectively 600 and 601) of a signal generated by a processing unit (respectively 24 and 26). And FIG. 6B represents an intrusive monitoring and diagnostic probe 100, which operates directly on a signal (respectively 600 and 601) generated by a processing unit (respectively 24 and 26).

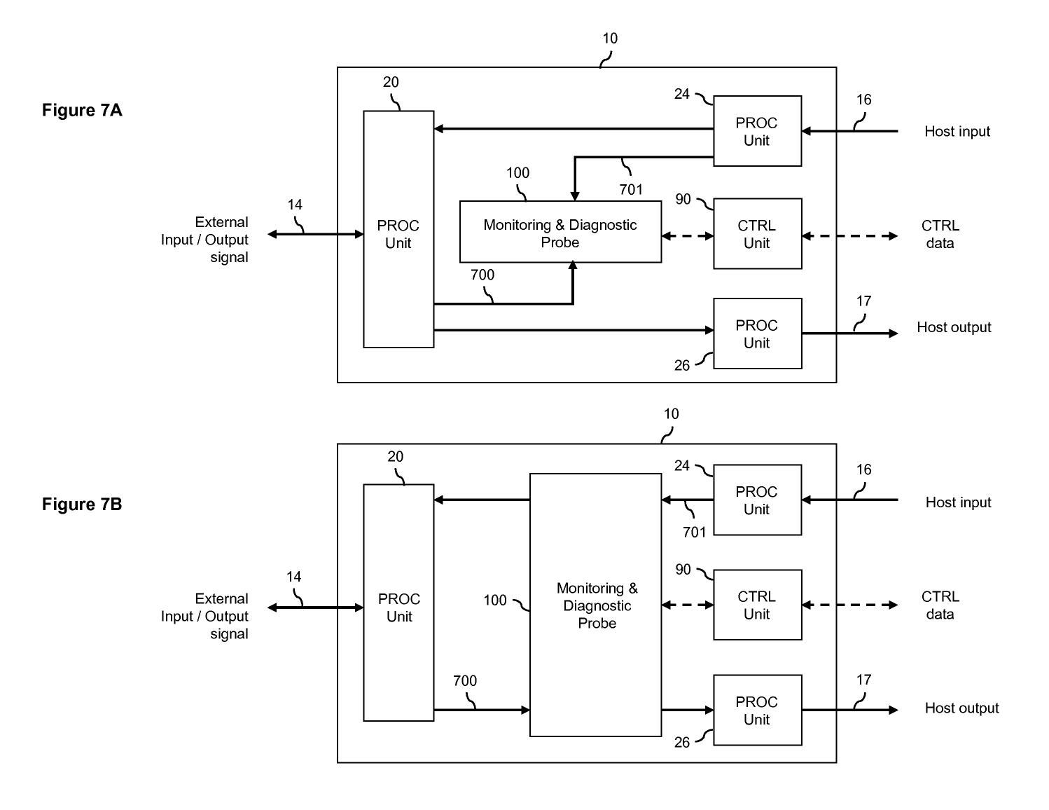

Referring now to FIGS. 7A and 7B, a monitoring and diagnostic probe for an SFP unit with one bi-directional port will be described.

In FIGS. 7A and 7B, the SFP unit 10 provides one bi-directional port. The input of the bi-directional port is illustrated by the input/output 14, the processing unit 20, the processing unit 26, and the host output 17. And the output of the bi-directional port is illustrated by the host input 16, the processing unit 24, the processing unit 20, and the input/output 14.

For the input of the bi-directional port, the monitoring and diagnostic probe 100 monitors a processed signal 700, generated by the processing (by the processing unit 20) of the external input signal received on the input 14. For the output of the bi-directional port, the monitoring and diagnostic probe 100 monitors a processed signal 701, generated by the processing (by the processing unit 24) of the host input signal received on the input 16.

FIG. 7A represents a non-intrusive monitoring and diagnostic probe 100, which operates on a copy (respectively 700 and 701) of a signal generated by a processing unit (respectively 20 and 24). And FIG. 7B represents an intrusive monitoring and diagnostic probe 100, which operates directly on a signal (respectively 700 and 701) generated by a processing unit (respectively 20 and 24).

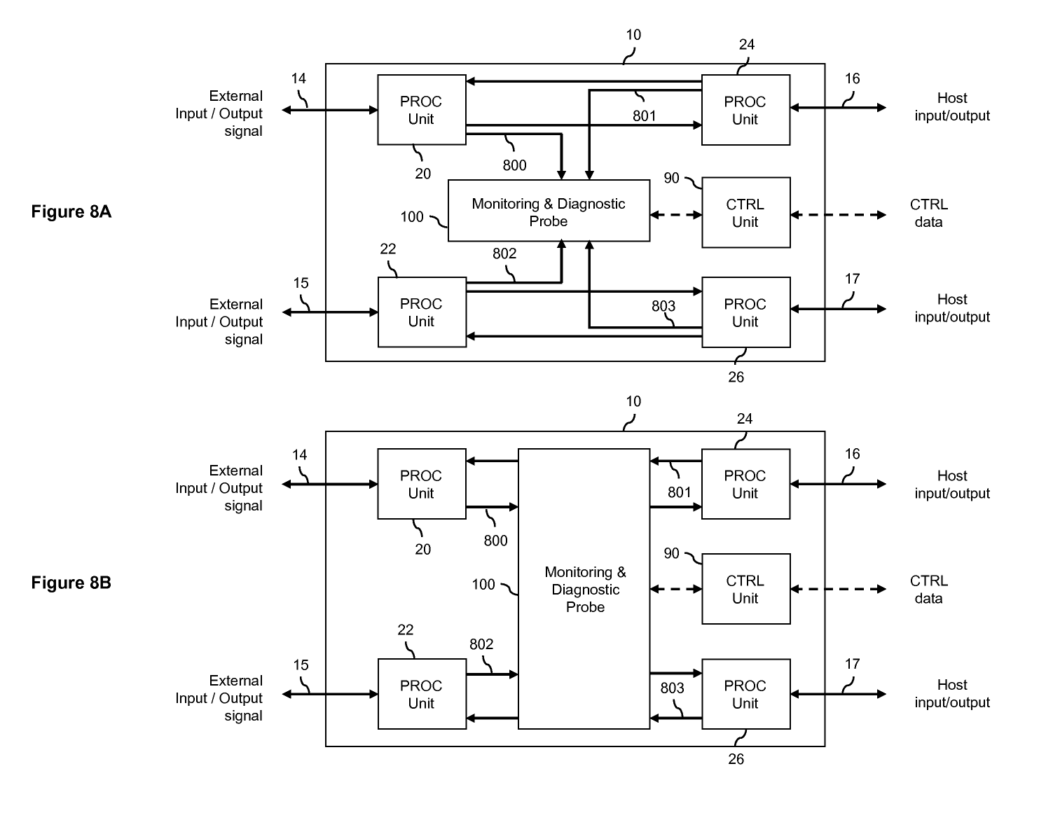

Referring now to FIGS. 8A and 8B, a monitoring and diagnostic probe for an SFP unit with two bi-directional ports will be described.

In FIGS. 8A and 8B, the SFP unit 10 provides two bi-directional connections. The monitoring and diagnostic probe 100 monitors a processed signal 800, generated by the processing (by the processing unit 20) of the external input signal received on the input/output 14, and monitors a processed signal 801, generated by the processing (by the processing unit 24) of the host input signal received on the host input/output 16.

Furthermore, the monitoring and diagnostic probe 100 monitors a processed signal 802, generated by the processing (by the processing unit 22) of the external input signal received on the input/output 15 and monitors a processed signal 803, generated by the processing (by the processing unit 26) of the host input signal received on the host input/output 17.

FIG. 8A represents a non-intrusive monitoring and diagnostic probe 100, which operates on a copy (respectively 800, 801, 802, and 803) of a signal generated by a processing unit (respectively 20, 24, 22, and 26). And FIG. 8B represents an intrusive monitoring and diagnostic probe 100, which operates directly on a signal (respectively 800, 801, 802, and 803) generated by a processing unit (respectively 20, 24, 22, and 26).

In FIGS. 2A to 8B, several embodiments of an SFP unit 10 with a monitoring and diagnostic probe 100 have been illustrated. These embodiments disclosed various configurations of the SFP unit 10, for which a monitoring and diagnostic functionality may be implemented by means of a monitoring and diagnostic probe 100. The configurations included SFP units with one or more inputs, one or more outputs, and one or mode bi-directional ports. Also, the configurations included SFP units with a combination of one or more inputs, and one or more host interfaces. And the configurations included SFP units with various combinations of processing units. Additional alternative configurations of an SFP unit 10 may be considered, for which a monitoring and diagnostic functionality may be implemented by means of a monitoring and diagnostic probe 100; within the scope of the present disclosure.

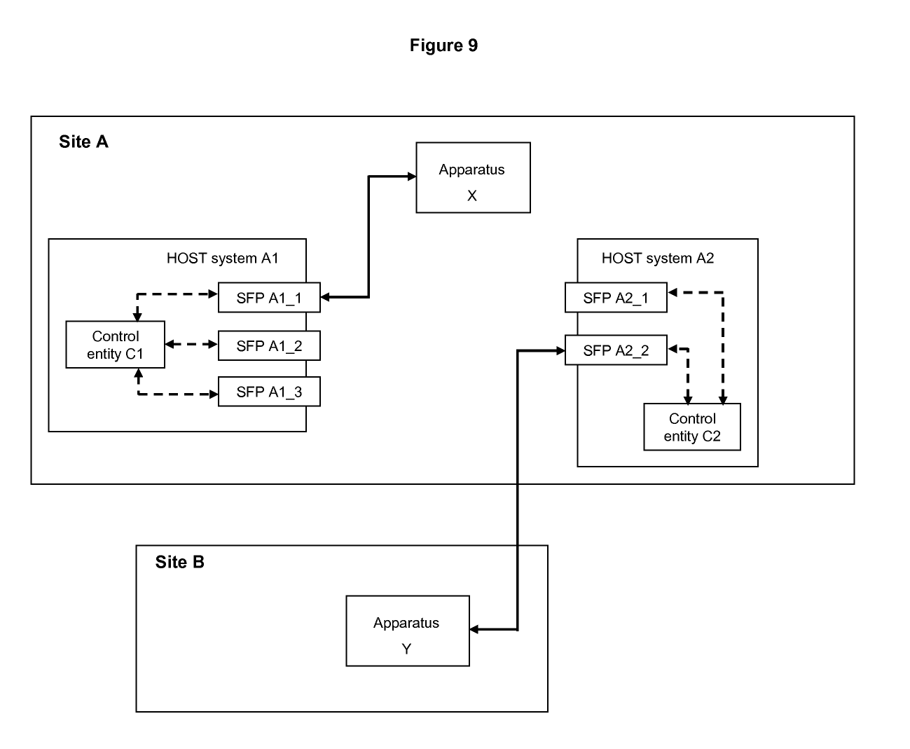

Referring now to FIG. 9, a monitoring and diagnostic system will be described.

A first Site A and a second site B are represented in FIG. 9. Sites A and B may be two different buildings; or alternatively may be two different rooms in the same building. Sites A and B include several electronic equipments, which may be communicating together and exchanging information, by means of a connection (for example, a coaxial cable connection, or an optical fiber connection).

Site A includes the following electronic equipments: a first host system A1, a second host system A2, and, an apparatus X. Site B includes the following electronic equipment: an apparatus Y.

Three SFP units SFP A1_1, SFP A1_2, and SFP A1_3, are connected to the host system A1 via at least one host interface respectively. SFP A1_1 is also connected to the apparatus X, via at least one input. Thus, host system A1 and apparatus X are communicating and exchanging information, via SFP A1_1.

Two SFP units SFP A2_1, and SFP A2_2, are connected to the host system A2 via at least one host interface respectively. SFP A2_2 is also connected to the apparatus Y, via at least one input. Thus, host system A2 and apparatus Y are communicating and exchanging information, via the SFP A2_2.

The host system A1 includes a control entity C1, for controlling the SFP units SFP A1_1, SFP A1_2, and SFP A1_3. The host system A2 includes a control entity C2, for controlling the SFP units SFP A2_1, and SFP A2_2. All the SFP units represented in FIG. 9 include a monitoring and diagnostic probe (not represented in FIG. 9).

The monitoring and diagnostic probe of SFP A1_1 monitors at least one signal received by SFP A1_1. The signal is received via at least one host interface connecting SFP A1_1 to host system A1. Or via at least one input connecting SFP A1_1 to apparatus X. The control entity C1 receives diagnostics generated by the monitoring and diagnostic probe of SFP A1_1. The diagnostics are representative of the monitoring of the at least one signal received by SFP A1_1.

Although not represented in FIG. 9 for simplification purposes, SFP A1_2 and SFP A1_3 may also be connected to apparatuses. The monitoring and diagnostic probes of SFP A1_2 and SFP A1_3 may also be monitoring at least one received signal or one transmitted signal, and sending diagnostics (representative of the monitoring) to the control entity C1.

The monitoring and diagnostic probe of SFP A2_2 monitors at least one signal received by SFP A2_2. The signal is received via at least one host interface connecting SFP A2_2 to host system A2. Or via at least one input connecting SFP A2_2 to apparatus Y. The control entity C2 receives diagnostics generated by the monitoring and diagnostic probe of SFP A2_2. The diagnostics are representative of the monitoring of the at least one signal received by SFP A2_2.

Although not represented in FIG. 9 for simplification purposes, SFP A2_1 may also be connected to an apparatus. The monitoring and diagnostic probes of SFP A2_1 may also be monitoring at least one received signal, and sending diagnostics (representative of the monitoring) to the control entity C2.

The monitoring and diagnostic probe of SFP A1_1 enables the monitoring of a communication between two equipments (host system A1 and apparatus X) of the same site (site A). The monitoring and diagnostic probe of SFP A2_2 enables the monitoring of a communication between two equipments (host system A2 and apparatus Y) from two different sites (site A and B respectively). These two monitoring and diagnostic probes are thus capable of detecting a problem in the communication between two equipments, and to identify which equipment may be the cause of the problem. For example, if the monitoring and diagnostic probe of SFP A1_1 detects a problem on a signal received from apparatus X, then apparatus X is probably responsible for the problem (the problem may also be due to the physical connection between SFP A1_1 and apparatus X). The problem on the signal received from apparatus X may cause a failure of host system A1. Without the monitoring and diagnostic probe of SEP A1_1, it may not be possible to determine if the failure of host system A1 is due to an internal problem in the operations of host system A1, or is due to a problem in the signal received from apparatus X.

Control entities C1 and C2 are capable of monitoring the SFP units under their control, and to analyze the diagnostics transmitted by the monitoring and diagnostics probes of these SFP units. Control entities C1 and C2 may further generate alerts, in relation to the received diagnostics. An alert may identify an equipment which may be in fault (the equipment is transmitting an erroneous signal detected by the monitoring and diagnostic probe of an SFP unit).

Although the present disclosure has been described in the foregoing description by way of illustrative embodiments thereof, these embodiments can be modified at will, within the scope of the appended claims without departing from the spirit and nature of the appended claims.

What is claimed is:

1. A small form-factor pluggable (SFP) unit comprising:
at least one input for receiving a signal;
a monitoring probe for monitoring the received signal and generating a corresponding status signal; and
at least one output for outputting the status signal.

2. The SFP unit of claim 1, wherein the at least one input comprises one of: video and/or data signals.

3. The SFP unit of claim 1, wherein the monitoring probe is non-intrusive and operates on a copy of the received signal.

4. The SFP unit of claim 1, wherein the monitoring probe is intrusive and operates on the received signal.

5. The SFP unit of claim 4, wherein the monitoring probe further alters a content of the received signal; the alteration comprising at least one of: a modification of the content of the received signal, and a restoration of the content of the received signal.

6. The SFP unit of claim 1, wherein the status signal comprises at least one of: audio quality parameter of the received signal, video quality parameter of the received signal, digital quality parameter of the received signal, integrity parameter of a content of the received signal.

7. The SFP unit of claim 1, wherein the monitoring probe further generates a diagnostic of the received signal.
